(19) United States
(12) Patent Application Publication
(10) Pub. No.: US 2019/0304048 A1
(43) Pub. Date: Oct. 3, 2019

(54) DISPLAY SYSTEM AND DISPLAY METHOD

(71) Applicant: Acer Incorporated, New Taipei City (TW)

(72) Inventors: Chan-Yuan Hu, New Taipei City (TW); Ruey-Ching Shyu, New Taipei City (TW); Chao-Kuang Yang, New Taipei City (TW)

(73) Assignee: Acer Incorporated, New Taipei City (TW)

(21) Appl. No.: 16/057,840

(22) Filed: Aug. 8, 2018

(30) Foreign Application Priority Data
Apr. 2, 2018 (TW) 107111608

(51) Int. Cl. G06T 1/20; G06T 9/00; G09G 5/00; G06F 3/14

(52) U.S. Cl. CPC G06T 1/20; G06T 9/00; G09G 2370/16; G06F 3/1423; G09G 5/003

(57) ABSTRACT

A display system and a display method are provided. The display system includes an electronic device and a first display device. The electronic device has a first graphics processing unit and a second graphics processing unit. The method includes the following. A first program is executed via the first graphics processing unit of the electronic device and at least one frame corresponding to the first program is generated. The at least one frame is obtained via the second graphics processing unit of the electronic device and the at least one frame is encoded. The frame encoded by the second graphics processing unit is transmitted to the first display device via the electronic device. The encoded frame is decoded via the first display device to display the at least one frame.

### CROSS-REFERENCE TO RELATED APPLICATION

This application claims the priority benefit of Taiwan application serial no. 107111608, filed on Apr. 2, 2018. The entirety of the above-mentioned patent application is hereby incorporated by reference herein and made a part of this specification.

### BACKGROUND OF THE INVENTION

### Field of the Invention

The invention relates to a display system having a plurality of graphics processing units and a display method thereof

### Description of Related Art

FIG. 1 is a schematic of the operation of a known electronic device having two graphics processing units. Referring to FIG. 1, an electronic device 100 (such as a computer) has a first graphics processing unit 12 and a second graphics processing unit 22, and the performance of the first graphics processing unit 12 is better than that of the second graphics processing unit 22. When the electronic device 100 executes a first program 10 requiring greater computation (such as a 3D game), the electronic device 100 generally automatically runs the first program 10 requiring greater computation on a single first graphics processing unit 12, and the second graphics processing unit 22 generally is responsible for processing other programs requiring less computation (referred to herein as a second program 20). In other words, when the first graphics processing unit 12 executes the first program 10 with greater computation, the second graphics processing unit 22 processes less amount of data or is idle.

In the example of FIG. 1, the first display device 18 is a wearable display device (such as a head-mounted display device) receiving data via a wireless transmission method. When the electronic device 100 is to display the execution result of the first program 10 in the first display device 18, the first graphics processing unit 12 executes the first program 10 to generate a frame 14, and the first graphics processing unit 12 performs an encoding operation 16 on the generated frame to compress the frame 14. Next, the electronic device 100 transmits the encoded frame to an output unit 50, and the output unit 50 transmits the encoded frame to the first display device 18 via a wireless transmission method for display. Moreover, the second display device 24 is, for instance, a display device connected to the electronic device 100 via a physical circuit. The second display device 24 can also directly obtain the frame 14 generated after the first graphics processing unit 12 executes the first program 10 via the output unit 50 or the image generated after the second graphics processing unit 22 executes the second program 20 for display.

In other words, if the output unit 50 displays the frame 14 of the first program 10 in the first display device 18 via wireless transmission, then the first graphics processing unit 12 is responsible for the execution of the first program 10 to generate the frame 14 and the encoding operation 16 encoding the frame 14. At this point, the computing load of the first graphics processing unit 12 is too heavy, and wireless transmission may be unstable.

### SUMMARY OF THE INVENTION

The invention provides a display system and a display method that can distribute the computing load of graphics processing units in an electronic device having a plurality of graphics processing units.

The invention provides a display system. The display system has an electronic device and a first display device. The electronic device has a first graphics processing unit and a second graphics processing unit. The first graphics processing unit of the electronic device executes a first program and generates at least one frame corresponding to the first program. The second graphics processing unit of the electronic device obtains the frame and encodes the frame. The electronic device transmits the frame encoded by the second graphics processing unit to the first display device and the first display device decodes the encoded frame to display the frame.

In an embodiment of the invention, in the operation in which the second graphics processing unit of the electronic device obtains the frame, a driver executed by the electronic device transmits a memory location of the frame in the electronic device to the second graphics processing unit, and the second graphics processing unit of the electronic device obtains the frame according to the memory location.

In an embodiment of the invention, in the operation in which the electronic device transmits the frame encoded by the second graphics processing unit to the first display device, the electronic device transmits the frame encoded by the second graphics processing unit to the first display device via a wireless communication method.

In an embodiment of the invention, the first display device is a wearable display device.

In an embodiment of the invention, the display system further includes a second display device connected to the electronic device in a wired manner. The second display device obtains the frame from the first graphics processing unit and displays the frame.

The invention provides a display method suitable for a display system. The display system includes an electronic device and a first display device. The electronic device has a first graphics processing unit and a second graphics processing unit. The method includes the following. A first program is executed via the first graphics processing unit of the electronic device and at least one frame corresponding to the first program is generated. The frame is obtained via the second graphics processing unit of the electronic device and the frame is encoded. The frame encoded by the second graphics processing unit is transmitted to the first display device via the electronic device. The encoded frame is decoded via the first display device to display the frame.

In an embodiment of the invention, the step of obtaining the frame via the second graphics processing unit of the electronic device includes the following. A memory location of the frame in the electronic device is transmitted to the second graphics processing unit via a driver executed by the electronic device. The frame is obtained according to the memory location via the second graphics processing unit of the electronic device.

In an embodiment of the invention, the step in which the image encoded by the second graphics processing unit is transmitted to the first display device via the electronic device includes the following: the frame encoded by the second graphics processing unit is transmitted to the first display device via a wireless communication method via the electronic device.

In an embodiment of the invention, the first display device is a wearable display device.

In an embodiment of the invention, the display system further includes connection to the second display device of the electronic device via a wired method, and the method further includes the following: the frame is obtained from the first graphics processing unit via the second display device and the frame is displayed.

Based on the above, the display system and the display method of the invention can distribute the computing load of graphics processing units in an electronic device having a plurality of graphics processing units. When wireless transmission is to be executed and the frame needs to be compressed via an encoding operation, a program can be executed via a graphics processing unit to generate a frame, and an encoding operation can be executed for the generated frame via another graphics processing unit. As a result, computation overload of a single graphics processing unit can be prevented, and unstable wireless transmission can be prevented.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic of the operation of a known electronic device having two graphics processing units.

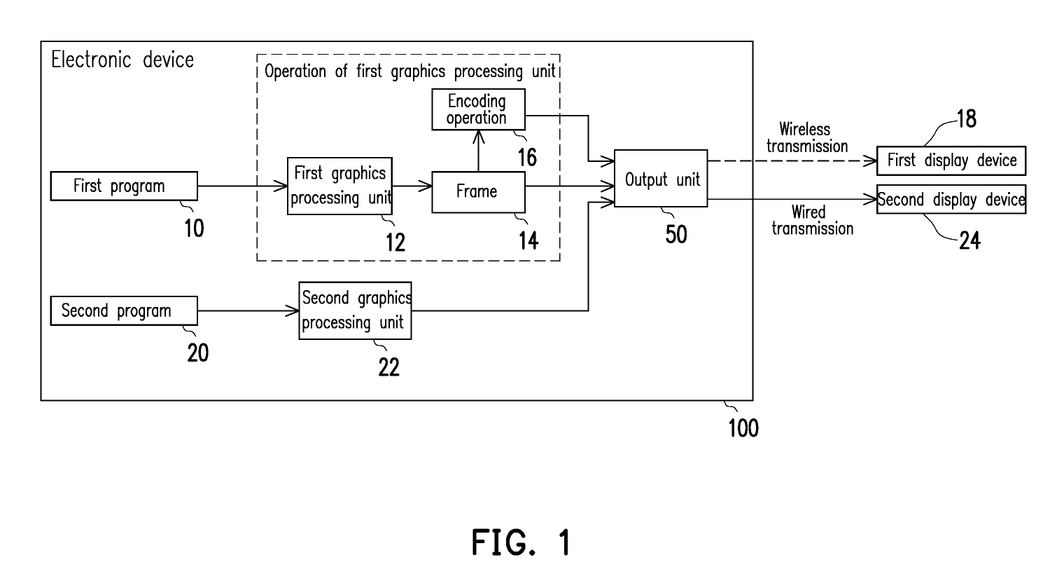

FIG. 2 is a schematic of a display system shown according to an embodiment of the invention.

FIG. 3 is a schematic of the operation of a display system shown according to an embodiment of the invention.

FIG. 4 is a flowchart of a display method shown according to an embodiment of the invention.

### DESCRIPTION OF THE EMBODIMENTS

Hereinafter, exemplary embodiments of the invention are described in detail with reference to figures. In addition, whenever possible, devices/members having the same reference numerals represent the same or similar parts in the figures and embodiments.

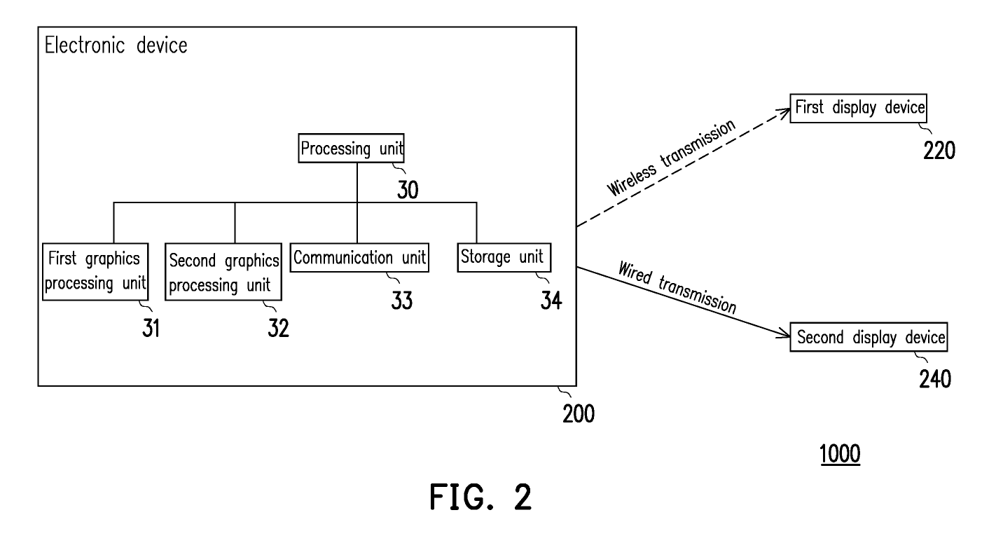

FIG. 2 is a schematic of a display system shown according to an embodiment of the invention.

Referring to FIG. 2, a display system 1000 includes an electronic device 200, a first display device 220, and a second display device 240. In particular, wireless transmission can be conducted between the electronic device 200 and the first display device 220 via wireless communication protocol. In the present exemplary embodiment, the wireless communication protocol is, for instance, the wireless transmission protocol of the Wireless Gigabit Alliance (WiGig) technique. However, the invention is not limited thereto, and in other embodiments, wireless transmission can also be conducted between the electronic device 200 and the first display device 220 via other wireless communication protocols. In the present exemplary embodiment, the first display device 220 is a wearable display device (such as a head-mounted display device) receiving data via a wireless transmission method.

Moreover, the second display device 240 is connected to the electronic device 200 via a wired method for wired transmission. The second display device 240 is, for instance, a regular computer screen or other display devices.

The electronic device 200 includes a processing unit 30, a first graphics processing unit 31, a second graphics processing unit 32, a communication unit 33, and a storage unit 34. In particular, the first graphics processing unit 31, the second graphics processing unit 32, the communication unit 33, and the storage unit 34 are respectively coupled to the processing unit 30. The electronic device 200 is, for instance, an electronic device such as a mobile phone, tablet computer, or notebook computer, and is not limited thereto.

The processing unit 30 can be a central processing unit (CPU) or a programmable general-purpose or application-specific microprocessor, digital signal processor (DSP), programmable controller, application-specific integrated circuit (ASIC), other similar devices, or a combination of the devices.

The first graphics processing unit 31 and the second graphics processing unit 32 can be regular graphics processing units (GPUs), display cores, visual processors, display chips, or graphic chips. The first graphics processing unit 31 and the second graphics processing unit 32 can be microprocessors executing graphics operations specifically on a personal computer, workstation, game console, and some mobile devices (such as a tablet computer or smart phone).

The communication unit 33 can be a global system for mobile communication (GSM), personal handy-phone system (PHS), code division multiple access (CDMA) system, wideband code division multiple access (WCDMA) system, long term evolution (LTE) system, worldwide interoperability for microwave access (WiMAX) system, wireless fidelity (Wi-Fi) system, Bluetooth, Wireless Gigabit Alliance (WiGig) technique, or other wired signal transmission devices. The electronic device 200 can respectively communicate with the first display device 220 and the second display device 240 via the communication unit 33.

The storage unit 34 can be any type of fixed or movable random-access memory (RAM), read-only memory (ROM), flash memory, a similar device, or a combination of the devices.

In the present exemplary embodiment, a plurality of code snippets is stored in the storage unit 34 of the electronic device 200, and after the code snippets are installed, the code snippets are executed by the processing unit 30. For instance, the storage unit 34 includes a plurality of modules, and each operation of the electronic device 200 applied in the display system 1000 is respectively executed via the modules, wherein each module is foil red by one or a plurality of code snippets. However, the invention is not limited thereto, and the various operations of the electronic device 200 can also be implemented in other hardware forms.

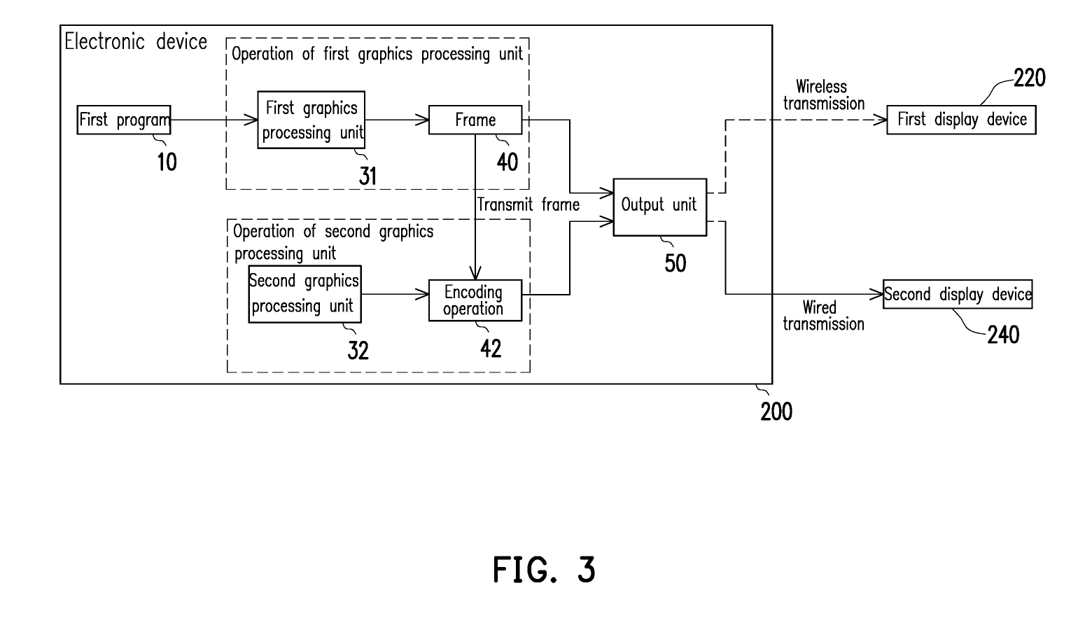

FIG. 3 is a schematic of the operation of a display system shown according to an embodiment of the invention.

Referring to FIG. 3, in the present exemplary embodiment, the output unit 50 can be a display chip supporting various wired and wireless display interfaces, such as a chip interface complying with USB Type-C, High Definition Multimedia Interface (HDMI), Display Port (DP), or Mini Display Port (MINI Port) or an internet interface card supporting a wireless display standard interface such as the airplay technique or Miracast standard based on Wi-Fi direct. In addition, the first graphics processing unit 31 and the second graphics processing unit 32 share at least one memory unit (which is referring as sharing memory unit hereafter). In other words, the sharing memory unit can be read by the first graphics processing unit 31 and the second graphics processing unit 32. Therefore, the first graphics processing unit 31 may share the data to the second graphics processing unit 32 by the memory location corresponding to the sharing memory unit.

Specifically, the first graphics processing unit 31 of the electronic device 200 executes a first program 10 (such as a 3D game) and generates at least one frame 40 corresponding to the first program 10. Next, a driver executed by the electronic device 200 transmits a memory location (which is corresponding to the sharing memory unit) of the frame 40 in the electronic device 200 to the output unit 50 and the second graphics processing unit 32. The second graphics processing unit 32 of the electronic device 200 can obtain the frame 40 according to the memory location which is corresponding to the sharing memory unit and transmitted by the driver. After the second graphics processing unit 32 of the electronic device 200 obtains the frame 40, the second graphics processing unit 32 performs an encoding operation 42 on the frame 40 and transmits the encoded frame to the output unit 50. Next, the electronic device 200 transmits the frame encoded by the second graphics processing unit 32 to the output unit 50 via a wireless transmission (i.e., wireless communication) method. As a result, the output unit 50 can output the encoded frame to the first display device 220 via a wired transmission method. The first display device 220 decodes the received encoded frame to display the frame 40.

Moreover, in an embodiment, the first display device 220 can also obtain the frame 40 generated after the first graphics processing unit 31 executes the first program 10 directly via the output unit 50 to display the frame 40.

It should be mentioned that, although not shown in FIG. 3, in other embodiments, the second graphics processing unit 32 can also be responsible for processing other programs requiring less computation (i.e., the second program 20). Moreover, although FIG. 3 only shows two graphics processing units, in other embodiments, the electronic device 200 can also have more graphics processing units, and the electronic device 200 can transmit the memory location, which is corresponding to the sharing memory unit, of the frame 40 in the electronic device 200 to a plurality of graphics processing units via a driver to be left idle or execute the encoding operation 42 via a graphics processing unit with less workload.

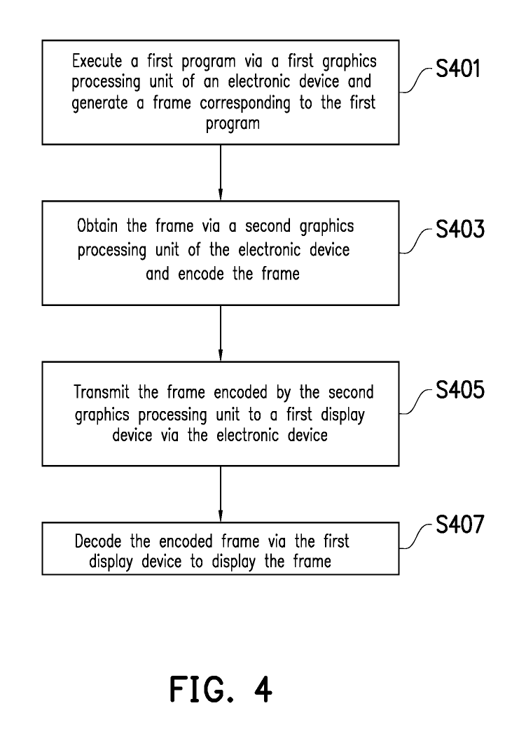

FIG. 4 is a flowchart of a display method shown according to an embodiment of the invention.

Referring to FIG. 4, in step S401, the first graphics processing unit 31 of the electronic device 200 executes the first program 10 and generates the at least one frame 40 corresponding to the first program 10. In step S403, the second graphics processing unit 32 of the electronic device 200 obtains the frame 40 and encodes the frame 40. In step S405, the electronic device 200 transmits the frame encoded by the second graphics processing unit 32 to the first display device 220. Next, in step S407, the first display device 220 decodes the encoded frame to display the frame 40.

It should be noted that, in the examples presented in the disclosure, the first graphics processing unit 31 may offload some image manipulations to the second graphics processing unit 32. For example, the second graphics processing unit 32 may execute a second program which is configured to color correction, scaling, vision computing or deep learning. However, the first graphics processing unit 31 may also offload other type of image manipulation to the second graphics processing unit 32. The type of second program is not limited thereto.

Based on the above, the display system and the display method of the invention can distribute the computing load of graphics processing units in an electronic device having a plurality of graphics processing units. When wireless transmission is to be executed and the frame needs to be compressed via an encoding operation, a program can be executed via a graphics processing unit to generate a frame, and an encoding operation can be executed for the generated frame via another graphics processing unit. As a result, computation overload of a single graphics processing unit can be prevented, and unstable wireless transmission can be prevented.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A display system, comprising:
an electronic device having a first graphics processing unit and a second graphics processing unit; and
a first display device, wherein
the first graphics processing unit of the electronic device executes a first program and generates at least one frame corresponding to the first program,
the second graphics processing unit of the electronic device obtains the at least one frame and encodes the at least one frame,
the electronic device transmits the at least one frame encoded by the second graphics processing unit to the first display device, and
the first display device decodes the encoded at least one frame to display the at least one frame.

2. The display system of claim 1, wherein in the operation in which the second graphics processing unit of the electronic device obtains the at least one frame,
a driver executed by the electronic device transmits a memory location of the at least one frame in the electronic device to the second graphics processing unit, and
the second graphics processing unit of the electronic device obtains the at least one frame according to the memory location.

3. The display system of claim 1, wherein in the operation in which the electronic device transmits the at least one frame encoded by the second graphics processing unit to the first display device,
the electronic device transmits the at least one frame encoded by the second graphics processing unit to the first display device via a wireless communication method.

4. The display system of claim 1, wherein the first display device is a wearable display device.

5. The display system of claim 1, further comprising:
a second display device connected to the electronic device via a wired method and obtaining the at least one frame from the first graphics processing unit and displaying the at least one frame.

6. The display system of claim 1, wherein the second graphics processing unit further executes a second program, the second program is configured to color correction, scaling, vision computing or deep learning.

7. A display method suitable for a display system, wherein the display system comprises an electronic device and a first display device, the electronic device has a first graphics processing unit and a second graphics processing unit, and the method comprises:
executing a first program via the first graphics processing unit of the electronic device and generating at least one frame corresponding to the first program;
obtaining the at least one frame via the second graphics processing unit of the electronic device and encoding the at least one frame;
transmitting the at least one frame encoded by the second graphics processing unit to the first display device via the electronic device; and
decoding the encoded at least one frame via the first display device to display the at least one frame.

8. The display method of claim 7, wherein the step of obtaining the at least one frame via the second graphics processing unit of the electronic device comprises:
transmitting a memory location of the at least one frame in the electronic device to the second graphics processing unit via a driver executed by the electronic device; and
obtaining the at least one frame according to the memory location via the second graphics processing unit of the electronic device.

9. The display method of claim 7, wherein the step of transmitting the at least one frame encoded by the second graphics processing unit to the first display device via the electronic device comprises:
transmitting the at least one frame encoded by the second graphics processing unit to the first display device via a wireless communication method via the electronic device.

10. The display method of claim 7, wherein the first display device is a wearable display device.

11. The display method of claim 7, wherein the display system further comprises a second display device connected to the electronic device via a wired method, the method further comprising:
obtaining the at least one frame from the first graphics processing unit via the second display device and displaying the at least one frame.

12. The display method of claim 7, further comprising:
executes a second program via the second graphics processing unit of the electronic device, the second program is configured to color correction, scaling, vision computing or deep learning.
